(19) United States
(12) Patent Application Publication
(10) Pub. No.: US 2024/0357680 A1
(43) Pub. Date: Oct. 24, 2024

(54) MULTI-LINK OPERATION WI-FI DUAL TRAFFIC IDENTIFICATION DATA TRANSMISSION METHOD

(71) Applicant: MEDIATEK INC., Hsin-Chu (TW)

(72) Inventors: Tsung-Jung Lee, Hsinchu City (TW); Ying-You Lin, Hsinchu City (TW); Cheng-Chien Su, Hsinchu City (TW); Kuo-Wei Chen, Hsinchu City (TW)

(73) Assignee: MEDIATEK INC., Hsin-Chu (TW)

(21) Appl. No.: 18/625,239

(22) Filed: Apr. 3, 2024

Related U.S. Application Data
(60) Provisional application No. 63/497,471, filed on Apr. 21, 2023.

(51) Int. Cl. H04W 76/15; H04L 5/00; H04W 84/12

(52) U.S. Cl. CPC H04W 76/15; H04L 5/0053; H04L 5/0092; H04W 84/12

(57) ABSTRACT

A multi-link operation (MLO) Wi-Fi dual traffic identification data transmission method is adopted for an MLO Wi-Fi access point (AP) and an MLO Wi-Fi client. The method includes linking the MLO Wi-Fi client to the MLO Wi-Fi access point (AP) with a first link and a second link, rendering traffic in the first link a first block acknowledgement (BA) window with a first traffic identification (TID), rendering traffic in the second link a second block acknowledgement (BA) window with a second traffic identification (TID), using the first block acknowledgement (BA) window with the first TID to transmit data through the first link, and using the second block acknowledgement (BA) window with the second TID to transmit data through the second link.

### CROSS REFERENCE TO RELATED APPLICATIONS

This application claims the benefit of U.S. Provisional Application No. 63/497,471, filed on Apr. 21, 2023. The content of the application is incorporated herein by reference.

### BACKGROUND

Wi-Fi products are tested by an independent authorized testing laboratory of the Wi-Fi Alliance. After the product successfully passes the test, the manufacturer or seller is granted the use of Wi-Fi logo, Wi-Fi certified logo and related trademarks. The Wi-Fi Alliance (WFA) uses the term “Wi-Fi CERTIFIED” to refer to such certified products. Certification means that the product can communicate with other Wi-Fi CERTIFIED devices that perform within the same frequency band. Wi-Fi Multimedia Quality of Service (WMM QOS) is a widely implemented quality of service management in Wi-Fi network, wherein WMM Qos prioritizes wireless traffics into four categories: voice, video, best effort, and background. These four categories of traffics are assigned with different admission controls (ACs).

The next generation Wi-Fi standard is currently being developed to achieve higher data rate, lower latency, and more reliable connection. The Wi-Fi Alliance (WFA) has developed Wi-Fi 7 certification based on the IEEE 802.11be draft specification to enhance user experience.

One of the key features of Wi-Fi 7 is Multi-Link Operation (MLO). As most current access points (APs) and stations incorporate dual-band or tri-band capabilities, the newly developed MLO feature enables packet-level link aggregation in the media access control (MAC) layer across different physical (PHY) links. By performing load balancing according to traffic requirements, MLO achieves significantly higher throughput and lower latency for enhanced reliability in a heavily loaded network.

With MLO capability, a multi-link device (MLD) allows data transmission and reception packets with different Qos requirements in multi links of multiple channels across a single or multiple frequency bands in 2 GHz, 5 GHZ and 6 GHz. Traffic identifier (TID) assigned in the packets represents the priorities of the QoS packets. For example, in Wi-Fi 7, the TID-to-link mapping mechanism included in MLO allows determination of how TIDs (Traffic identifiers) are mapped to the links in downlink (DL) and in uplink (UL), and is helpful for the use of preferred link(s) for TID(s) corresponding to high-priority and latency-sensitive traffics.

However, in a conventional MLO device, multiple links in one MLO share the same traffic identification (TID) and block acknowledgement (BA) window. When a packet transmission fails, the multi-link device (MLD) needs to retransmit some data using the block acknowledgement (BA) window with the traffic identification (TID) through link 0. While the BA window is utilized for transmitting data through link 0, the BA window cannot be utilized for transmitting data through another link such as link 1. Thus link 1 in another frequency band is idle and can transmit data only after link 0 finishes transmitting data, resulting in a low throughput.

FIG. 1 is a bar chart of the multi-link operation (MLO) peak throughput versus transmission packet error rate (PER) according to prior art. The MLO peak throughputs are 15, 500 Mbps and 13, 200 Mbps when transmission packet error rates (PER) are 0% and 18, respectively. The media access control (MAC) efficiencies of MLO are 84% and 71% when transmission packet error rates (PER) are 0% and 1%, respectively. FIG. 1 shows that the MAC efficiency decreases 13% when the transmission PER increases from 0% to 18. As transmission PER increases, data retransmission increases correspondingly. This will increase channel idle when a link is retransmitting data using the only block acknowledgement (BA) window with the only traffic identification (TID).

### SUMMARY

An embodiment provides a multi-link operation (MLO) Wi-Fi dual traffic identification data transmission method adopted for an MLO Wi-Fi access point (AP) and an MLO Wi-Fi client. The method includes setting an MLO Wi-Fi access point (AP) and an MLO Wi-Fi client, linking the MLO Wi-Fi client to the MLO Wi-Fi access point (AP) with a first link and a second link, rendering traffic in the first link a first block acknowledgement (BA) window with a first traffic identification (TID), rendering traffic in the second link a second block acknowledgement (BA) window second traffic with a identification (TID), using the first block acknowledgement (BA) window with the first TID to transmit data through the first link, and using the second block acknowledgement (BA) window with the second TID to transmit data through the second link.

Another embodiment provides a multi-link operation (MLO) Wi-Fi dual traffic identification data transmission method. The MLO Wi-Fi dual traffic identification data transmission method is adopted for an MLO Wi-Fi access point (AP) and an MLO Wi-Fi client. The method includes setting an MLO Wi-Fi access point (AP) and an MLO Wi-Fi client, linking the MLO Wi-Fi client to the MLO Wi-Fi access point (AP) with a first link, a second link and a third link, rendering traffic in the first link a first block acknowledgement (BA) window with a first traffic identification (TID), rendering traffic in the second link a second block acknowledgement (BA) window with a second traffic identification (TID), rendering traffic in the third link the second block acknowledgement (BA) window with the second traffic identification (TID), using the first block acknowledgement (BA) window with the first TID to transmit data through the first link, and using the second block acknowledgement (BA) window with the second TID to transmit data through the second link and the third link.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a bar chart of the multi-link operation (MLO) peak throughput versus transmission packet error rate (PER) according to prior art.

FIG. 2 is a conventional traffic identification (TID) architecture of multi-link operation (MLO) and triple band triple concurrent (TBTC).

FIG. 3 is media access control (MAC) efficiency versus transmission (TX) packet error rate (PER) according to an embodiment of the present invention.

FIG. 4 is a flow chart of an MLO Wi-Fi dual traffic identification (TID) data transmission method with two links according to an embodiment of the present invention.

FIG. 5 is a flow chart of an MLO Wi-Fi dual traffic identification (TID) data transmission method with three links according to an embodiment of the present invention.

FIG. 6 is a schematic diagram of an MLO Wi-Fi dual traffic identification (TID) data transmission method with two or three links according to an embodiment of the present invention.

### DETAILED DESCRIPTION

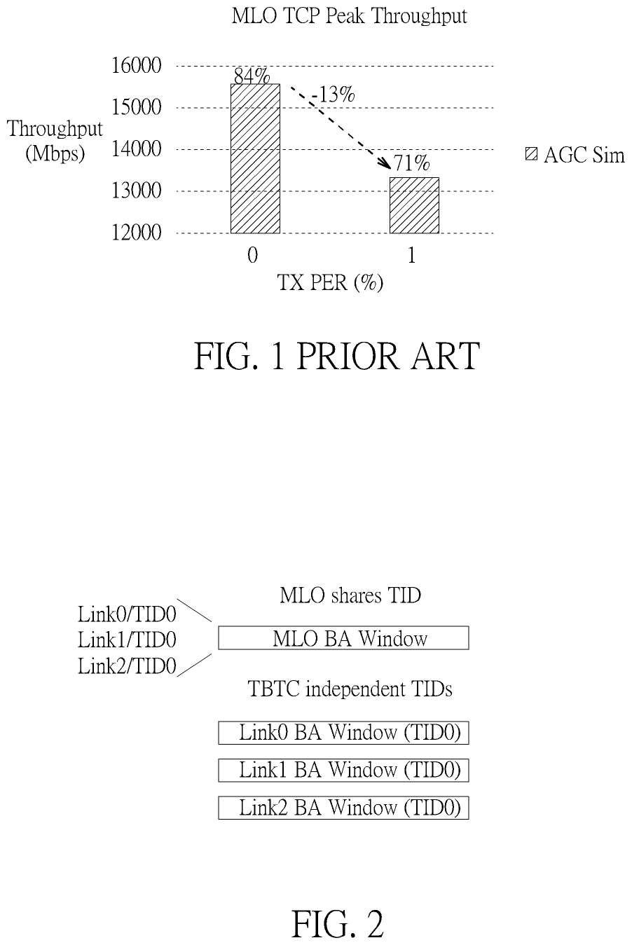

FIG. 2 is a conventional traffic identification (TID) architecture of multi-link operation (MLO) and triple band triple concurrent (TBTC). In conventional MLO traffic architecture, three links link0, link1, and link2 not only share the same traffic identification TID0, but also the same block acknowledgement (BA) window. Therefore, since MLO shares the windows and has the simultaneous transmission capability, transmitter (TX) window may exhaust easily. When the TX BA window is exhausted, the link TX will be blocked. Meanwhile, triple band triple concurrent (TBTC) technology uses the same TID in independent BA windows in the three links. Link0 uses an independent BA window with traffic identification TID0, link1 uses an independent BA window with traffic identification TID0, and link2 uses an independent BA window with traffic identification TID0. The three links can transmit data at the same time because three independent BA windows are available to transmit data on the three links link0, link1, and link2. However, when transmission of some packets in a BA window fails, re-transmission causes a lot of idling BA time, and aggregation efficiency of the packet protocol data unit (PPDU) would be deteriorated.

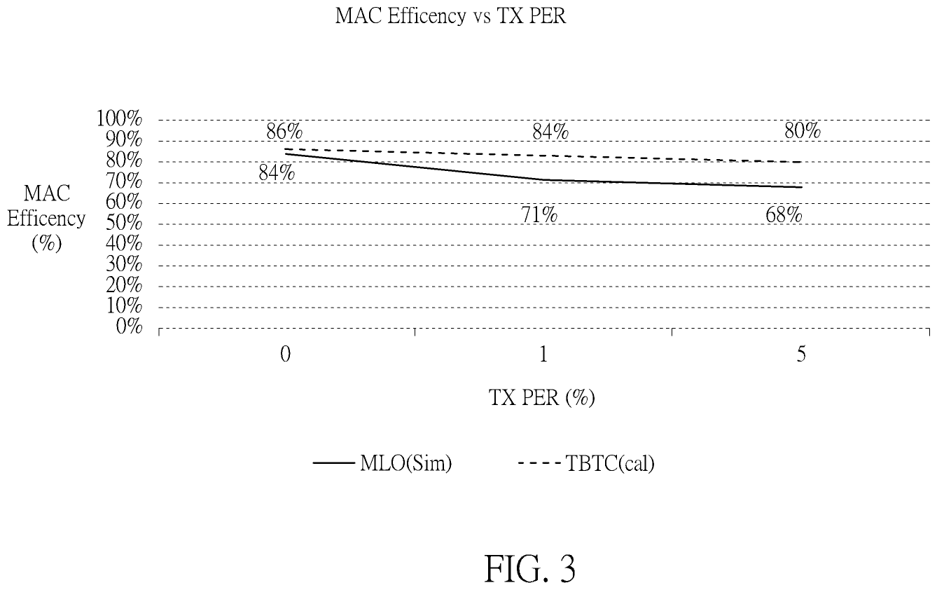

FIG. 3 is media access control (MAC) efficiency versus transmission (TX) packet error rate (PER) according to an embodiment of the present invention. The media access control (MAC) efficiencies are 86%, 84%, and 80% for triple band triple concurrent (TBTC) when the transmission packet error rates (PERs) are 0%, 18, and 5%, respectively. The media access control (MAC) efficiencies are 84%, 71%, and 68% for multi-link operation (MLO) when the transmission packet error rates (PERs) are 08, 1%, and 5%, respectively. The decays are 2% and 13% for triple band triple concurrent (TBTC) and multi-link operation (MLO) when the transmission packet error rate (PER) increases from 0% to 1%, respectively. The decays are 6% and 16% for triple band triple concurrent (TBTC) and multi-link operation (MLO) when the transmission packet error rate (PER) increases from 0% to 5%, respectively. The results show that the same traffic identification (TID0) with triple block acknowledgement (BA) windows retain the MAC efficiency better than the MLO with only one BA window when the transmission packet error rate (PER) increases. The MLO with only one BA window suffers from a significant throughput decrease when the transmission packet error rate (PER) increases.

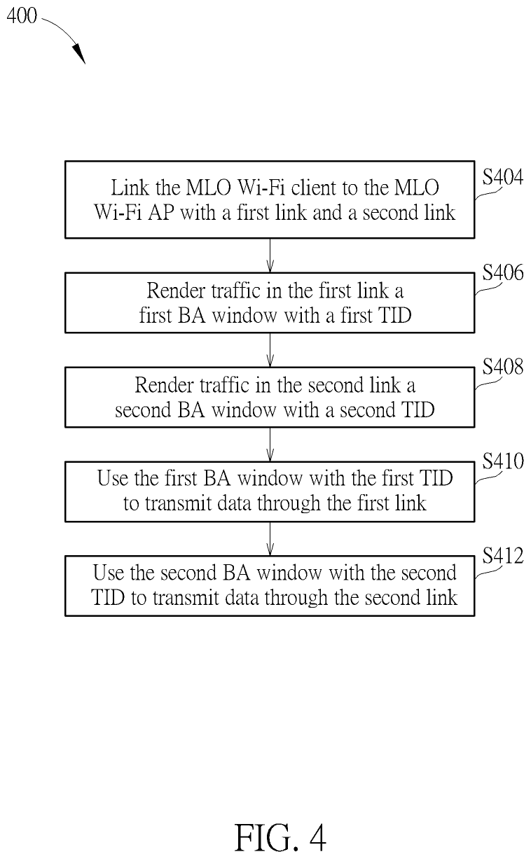

FIG. 4 is a flow chart of an MLO Wi-Fi dual traffic identification (TID) data transmission method 400 with two links according to an embodiment of the present invention. The MLO Wi-Fi dual traffic identification (TID) data transmission method 400 with two links is adopted for an MLO Wi-Fi access point (AP) and an MLO Wi-Fi client set in the environment. The method 400 includes the following steps:

Step S404: link the MLO Wi-Fi client to the MLO Wi-Fi AP with a first link and a second link;

Step S406: render traffic in the first link a first block acknowledgement (BA) window with a first traffic identification (TID);

Step S408: render traffic in the second link a second block acknowledgement (BA) window with a second traffic identification (TID), wherein the rendering comprises setting the second TID to have the same traffic priority as the first TID in the first link. For example, if the first link uses TID0, then the secondary link will use TID3, wherein TID3 is assigned with the same QoS priority or same admission control (AC) as the TID0 in one QoS operation;

Step S410: use the first BA window with the first TID to transmit data through the first link; and

Step S412: use the second BA window with the second TID to transmit data through the second link.

In Step S404, the MLO Wi-Fi access point (AP) and the MLO client are linked through the first link and the second link. In an embodiment, the first link and the second link can be 2 GHz and 5 GHz, respectively. In another embodiment, the first link and the second link can be 5 GHz and 6 GHz, respectively. In another embodiment, the first link and the second link can be 2 GHz and 6 GHz, respectively.

In Step S406 and S408, traffics in the first link and the second link are rendered the first BA window with the first TID and the second BA window with the second TID, respectively. It is to be noted that, the second TID should be set to have the same traffic priority as the first TID. For example, if traffic in the first link uses TID0, then traffic in the secondary link will use TID3, wherein TID3 is assigned with the same Qos priority or same admission control (AC) as that of TID0 in a QoS operation. In step S410, the first BA window with the first TID is used to transmit data through the first link. In step S412, the second BA window with the second TID is used to transmit data through the second link. In an embodiment, the MLO Wi-Fi access point (AP) can transmit data using the first BA window with the first TID through the first link and using the second BA window with the second TID through the second link simultaneously.

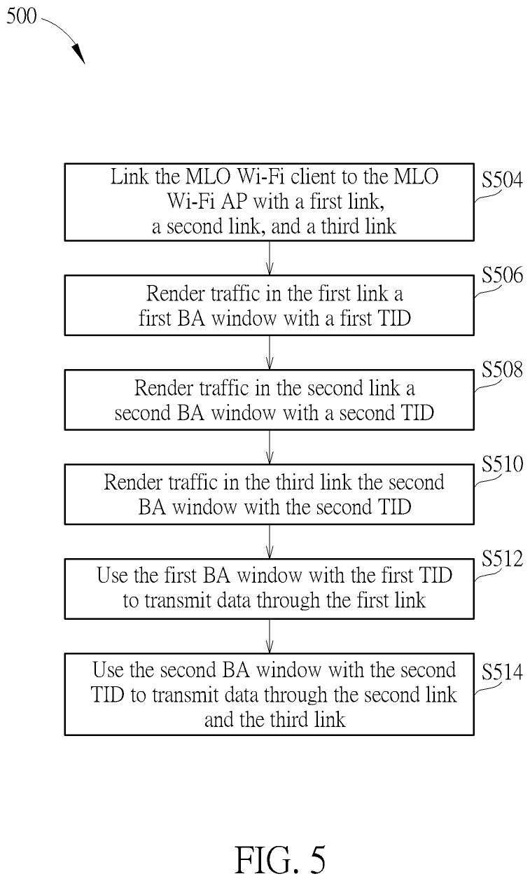

FIG. 5 is a flow chart of an MLO Wi-Fi dual traffic identification (TID) data transmission method 500 with three links according to an embodiment of the present invention. The MLO Wi-Fi dual traffic identification (TID) data transmission method 500 with three links is adopted for an MLO Wi-Fi access point (AP) and an MLO Wi-Fi client set in the environment. The method 500 includes the following steps:

Step S504: link the MLO Wi-Fi client to the MLO Wi-Fi AP with a first link, a second link, and a third link;

Step S506: render traffic in the first link a first block acknowledgement (BA) window with a first traffic identification (TID);

Step S508: render traffic in the second link a second block acknowledgement (BA) window with a second traffic identification (TID), wherein the rendering comprises setting the second TID to have the same traffic priority as the first TID in the first link. For example, if the first link uses TID0, then the secondary link will use TID3, wherein TID3 is assigned with the same QoS priority or same admission control (AC) as the TID0 in one QoS operation;

Step S510: render traffic in the third link the second block acknowledgement (BA) window with the second traffic identification (TID);

Step S512: use the first BA window with the first TID to transmit data through the first link; and

Step S514: use the second BA window with the second TID to transmit data through the second link and the third link.

In Step S504, the MLO Wi-Fi access point (AP) and the MLO Wi-Fi client are linked through the first link, the second link and the third link. In an embodiment, the first link, the second link and the third link can be 2 GHz, 5 GHZ and 6 GHz, respectively. In another embodiment, the first link, the second link and the third link can be 5 GHZ, 2 GHZ and 6 GHz, respectively. In another embodiment, the first link, the second link and the third link can be 6 GHZ, 2 GHZ and 5 GHz, respectively. In Step S506, S508 and S510, traffics in the first link, the second link and the third link are rendered the first BA window with the first TID and the second BA window with the second TID. It is to be noted that, the second TID should be set to have the same traffic priority as the first TID. In this example, the third link shares the same TID and the same BA window with the second link. For example, if traffic in the first link uses TID2, then traffic in the secondary link will use TID4, wherein TID4 is assigned with the same QoS priority or same admission control (AC) as that of TID2 in a Qos operation. And, traffic in the third link shares the TID4 and second BA window with the second link. In step S512, the first BA window with the first TID is used to transmit data through the first link. In step S514, the second BA window with the second TID is used to transmit data through the second link and the third link. In an embodiment, the MLO Wi-Fi access point (AP) can transmit data using the first BA window with the first TID through the first link and using the second BA window with the second TID through the second link simultaneously. In another embodiment, the MLO Wi-Fi access point (AP) can transmit data using the second BA window with the second TID through the second link and the third link alternatively. In yet another embodiment, the MLO Wi-Fi access point (AP) can transmit data using the first BA window with the first TID through the first link and using the second BA window with the second TID through the second link and/or the third link simultaneously.

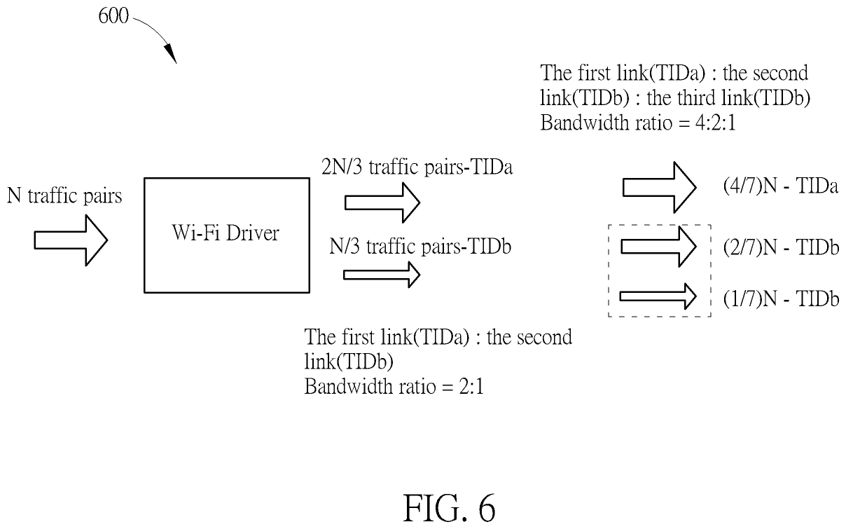

FIG. 6 is a schematic diagram of an MLO Wi-Fi dual traffic identification (TID) data transmission method 600 with two or three links according to an embodiment of the present invention. There are N traffic pairs to be transmitted. If the MLO Wi-Fi access point (AP) and the MLO client are linked through the first link and the second link, and the bandwidth ratio of the first link and the second link is 2:1, the 2/3 of N traffic pairs will be transmitted by the first link, and 1/3 of N traffic pairs will be transmitted by the second link. The traffic pairs to be transmitted are distributed in multiple links according to the bandwidth ratio of the links. Therefore, in this embodiment, the MLO Wi-Fi client transmits the 2N/3 traffic pairs through the first link with TIDa and N/3 traffic pairs through the second link with TIDb using the bandwidth ratio 2:1.

If the MLO Wi-Fi access point (AP) and the MLO client are linked through the first link, the second link, and the third link, and the bandwidth ratio of the first link, the second link, and the third link is 4:2:1, the 4/7 of N traffic pairs will be transmitted by the first link, the 2/7 of N traffic pairs will be transmitted by the second link, and the 1/7 of N traffic pairs will be transmitted by the third link. The traffic pairs to be transmitted are distributed in multiple links according to the bandwidth ratio of the links. Therefore, in this embodiment, the MLO Wi-Fi client transmits the 4N/7 traffic pairs through the first link with TIDa, 2N/7 traffic pairs through the second link with TIDb, and N/7 traffic pairs through the third link with TIDb using the bandwidth ratio 4:2:1.

In conclusion, the MLO Wi-Fi dual traffic identification data transmission method is implemented to achieve low MAC efficiency decay when the packet error rate (PER) increases. The solution includes dual TIDs with two links and dual TIDs with three links, and MLO Wi-Fi with dual TIDs increases the throughput when packet transmission fails, thus improving the performance of data communications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-link operation (MLO) Wi-Fi dual traffic identification data transmission method adopted for an MLO Wi-Fi access point (AP) and an MLO Wi-Fi client, the method comprising:
linking the MLO Wi-Fi client to the MLO Wi-Fi access point (AP) with a first link and a second link;
rendering traffic in the first link a first block acknowledgement (BA) window with a first traffic identification (TID);
rendering traffic in the second link a second block acknowledgement (BA) window with a second traffic identification (TID);
using the first block acknowledgement (BA) window with the first TID to transmit data through the first link; and
using the second block acknowledgement (BA) window with the second TID to transmit data through the second link.

2. The method of claim 1, wherein the first link is a 2 GHz link and the second link is a 5 GHz link.

3. The method of claim 1, wherein the first link is a 2 GHz link and the second link is a 6 GHz link.

4. The method of claim 1, wherein the first link is a 5 GHz link and the second link is a 6 GHz link.

5. The method of claim 1, wherein data is transmitted through the first link and the second link simultaneously.

6. A multi-link operation (MLO) Wi-Fi dual traffic identification data transmission method, adopted for an MLO Wi-Fi access point (AP) and an MLO Wi-Fi client, the method comprising:
linking the MLO Wi-Fi client to the MLO Wi-Fi access point (AP) with a first link, a second link and a third link;
rendering traffic in the first link a first block acknowledgement (BA) window with a first traffic identification (TID);
rendering traffic in the second link a second block acknowledgement (BA) window with a second traffic identification (TID);
rendering traffic in the third link the second block acknowledgement (BA) window with the second traffic identification (TID);
using the first block acknowledgement (BA) window with the first TID to transmit data through the first link; and
using the second block acknowledgement (BA) window with the second TID to transmit data through the second link and the third link.

7. The method of claim 6, wherein the first link is a 2 GHz link, the second link is a 5 GHz link and the third link is a 6 GHz link.

8. The method of claim 6, wherein the first link is a 5 GHz link, the second link is a 2 GHz link and the third link is a 6 GHz link.

9. The method of claim 6, wherein the first link is a 6 GHz link, the second link is a 2 GHz link and the third link is a 5 GHz link.

10. The method of claim 6, wherein data is transmitted through the first link, the second link and the third link simultaneously.

11. The method of claim 6, wherein data is transmitted through the first link and the second link simultaneously.

12. The method of claim 6, wherein data is transmitted through the second link and the third link simultaneously.
